(19) United States
(12) Patent Application Publication
(10) Pub. No.: US 2024/0046645 A1
(43) Pub. Date: Feb. 8, 2024

(54) LEARNING DEVICE, INFERENCE DEVICE, LEARNING METHOD, AND INFERENCE METHOD

(71) Applicant: NTT Communications Corporation, Tokyo (JP)

(72) Inventor: Shuhei TARASHIMA, Yokohama-shi (JP)

(21) Appl. No.: 18/482,310

(22) Filed: Oct. 6, 2023

Related U.S. Application Data
(63) Continuation of application No. PCT/JP2021/045354, filed on Dec. 9, 2021.

(30) Foreign Application Priority Data
Jun. 8, 2021 (JP) 2021-096082

(51) Int. Cl. G06V 20/40; G06V 10/776; G06V 10/82; G06V 10/77

(52) U.S. Cl. CPC G06V 20/41; G06V 10/776; G06V 20/46; G06V 10/82; G06V 10/7715

(57) ABSTRACT

A learning device includes a convolutional neural network configured to output action, re-identification, size, and position feature maps in response to respective image frames constituting a video sequence being input; a processor; and a memory storing program instructions that cause the processor to: receive the action feature map, the re-identification feature map, and the size feature map to output an action feature, a re-identification feature, and a size feature; receive the action feature and the re-identification feature to output a feature obtained by considering an interaction between features; output a group activity classification result based on the output feature; output an action classification result based on the output feature; and update model parameters of the convolutional neural network so as to minimize an error between the position feature map, the size feature, the re-identification feature, the group activity classification result, and the action classification result; and correct data.

### CROSS-REFERENCE TO RELATED APPLICATIONS

This application is a continuation application of International Application No. PCT/JP2021/045354 filed on Dec. 9, 2021, and designating the U.S., which is based upon and claims priority to Japanese Patent Application No. 2021-096082, filed on Jun. 8, 2021, the entire contents of which are incorporated herein by reference.

### BACKGROUND

### 1. Technical Field

The present disclosure relates to a technique for detecting and tracking an object appearing in an input video, identifying an action taken by each object to be tracked, and identifying, in a case where multiple objects are appearing in the video, a group activity that is an activity formed by a group of the multiple objects.

### 2. Description of the Related Art

An example of a technique for identifying such a group activity is illustrated in FIG. 1. In the example illustrated in FIG. 1, a person appearing in an input video is detected and tracked, an action (an individual action) taken by each person to be tracked is identified, and in a case where multiple persons are appearing, a group activity formed by a group of the multiple persons is identified.

FIG. 1 illustrates an example in which actions of first and second track results are identified as “moving”, a third action is identified as “waiting”, and an activity taken by a group formed by the persons to be tracked is identified as “moving”. Hereinafter, the above problem will be referred to as “activity recognition”.

When the above-described activity recognition is realized, an action of an individual appearing in a video can be automatically recognized. This can be applied, for example, to monitoring abnormal activity in videos captured by cameras installed throughout a city. At the same time, not only individual actions but also an activity taken by a group formed by multiple objects can be automatically recognized. This enables a set play formed by cooperation of multiple players in sport to be recognized and an abnormal activity taken by a group captured by a camera in a city to be detected, thereby expanding the range of analysis application of a sport video and a monitoring video.

From the above, it can be found that the industrial applicability of activity recognition is extremely high.

When the above-described activity recognition is performed using a conventional technique, there is a problem in that the entire architecture becomes complicated and redundant, processing takes time, and performance of activity recognition is low.

### RELATED ART DOCUMENT

### Non-Patent Document

[Non-Patent Document 1] J. Redmon, S. Divvala, R. Girshick, and A. Farhadi. You only look once: Unified, real-time object detection. In CVPR, 2016.
[Non-Patent Document 2] L. Chen, H. Ai, Z. Zhuang, and C. Shang. Real-time multiple people tracking with deeply learned candidate selection and person re-identification. In ICME, 2018.
[Non-Patent Document 3] J. Wu, L. Wang, L. Wang, J. Guo, and G. Wu. Learning actor relation graphs for group activity recognition. In CVPR, 2019.
[Non-Patent Document 4] F. Yu, D. Wang, E. Shelhamer, and T. Darrell. Deep layer aggregation. In CVPR, 2018.
[Non-Patent Document 5] K. Sun, B. Xiao, D. Liu, and J. Wang. Deep high-resolution representation learning for human pose estimation. In CVPR, 2019.
[Non-Patent Document 6] J. L. Ba, J. R. Kiros, and G. E Hinton. Layer normalization. arXiv preprint arxiv:1607.06450, 2016.
[Non-Patent Document 7] N. Srivastava, G. E. Hinton, A. Krizhevsky, I. Sutskever, and R. Salakhutdinov. Dropout: a simple way to prevent neural networks from overfitting. JMLR, 2014.
[Non-Patent Document 8] Y. Zhang, C. Wang, X. Wang, W. Zeng, and W. Liu. Fairmot: On the fairness of detection and re-identification in multiple object tracking. In arXiv preprint arXiv:2004.01888v5, 2020.
[Non-Patent Document 9] F. Schroff, D. Kalenichenko, and J. Philbin. Facenet: A unified embedding for face recognition and clustering. In CVPR, 2015.
[Non-Patent Document 10] D. P. Kingma and J. L. Ba. Adam: a method for stochastic optimization. In ICLR, 2015.

### SUMMARY

According to one embodiment of the present disclosure, a learning device that performs learning for activity recognition, includes a convolutional neural network configured to output an action feature map, a re-identification feature map, a size feature map, and a position feature map in response to respective image frames constituting a video sequence being input; a processor; and a memory storing program instructions that cause the processor to: receive the action feature map, the re-identification feature map, and the size feature map to output an action feature, a re-identification feature, and a size feature; receive the action feature and the re-identification feature to output a feature obtained by considering an interaction between features; output a group activity classification result based on the output feature; output an action classification result based on the output feature; and update model parameters of the convolutional neural network so as to minimize an error between the position feature map, the size feature, the re-identification feature, the group activity classification result, and the action classification result; and correct data.

### BRIEF DESCRIPTION OF THE DRAWINGS

FIG. 1 is a diagram depicting activity recognition;

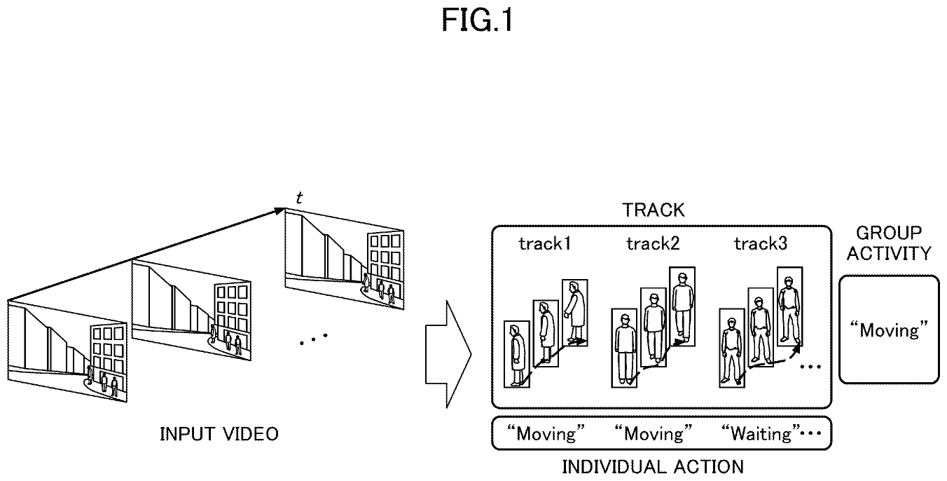

FIG. 2 is a diagram illustrating a scheme assumed from a publicly-known technique and a technique according to the present disclosure;

FIG. 3 is a diagram illustrating a convolutional neural network;

FIG. 4 is a diagram illustrating training data per one video sequence;

FIG. 5 is a diagram illustrating a learning device according to a first embodiment;

FIG. 6 is a diagram illustrating an inference device according to the first embodiment;

FIG. 7 is a diagram illustrating a learning device according to a second embodiment;

FIG. 8 is a diagram illustrating an inference device according to the second embodiment;

FIG. 9 is a diagram illustrating a learning device according to a third embodiment;

FIG. 10 is a diagram illustrating an inference device according to the third embodiment; and

FIG. 11 is a diagram illustrating an example of a hardware configuration of a device.

### DETAILED DESCRIPTION

According to the disclosed technique, an activity recognition technique in which processing cost is reduced using a simple architecture can be provided.

In the following, embodiments of the present disclosure will be described with reference to the drawings. The embodiments described below are merely examples, and the embodiments to which the present disclosure is applied are not limited to the following embodiments. In the following, first, the problem will be described in more detail, and then a learning device and an inference device according to the present embodiment will be described.

(Problem)

The activity recognition described in the background art includes multiple subtasks. Specifically, it is necessary to perform detection of a target object in respective frames constituting a video, association (tracking) of detection results between the frames, identification of an action of each detection or track result, and identification of a group activity formed by the entirety of the detection/track results.

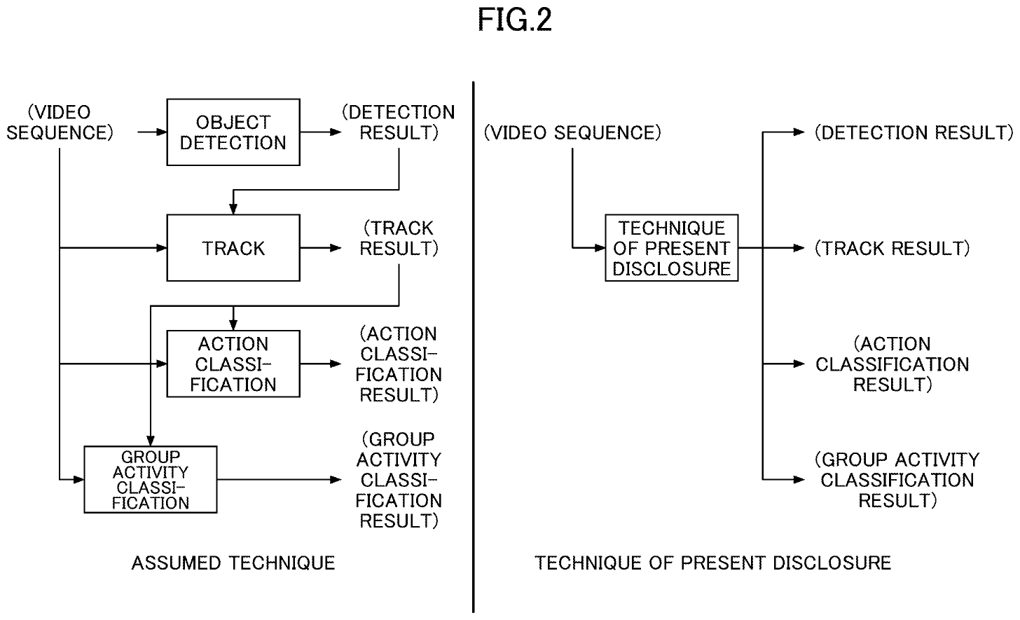

A processing configuration example in a case where activity recognition is performed using a publicly-known technique is illustrated on the left side of FIG. 2. Here, the configuration itself illustrated on the left side of FIG. 2 is not publicly-known. As illustrated on the left side of FIG. 2, in order to perform activity recognition using a publicly-known technique, results output by using multiple methods for independently solving the above-described subtasks are combined. A specific example is as follows.

First, a target object is detected from each video frame by the method disclosed in Non-Patent Document 1. Subsequently, a track result is output based on the obtained detection result by the method disclosed in Non-Patent Document 2. In parallel, by using the method disclosed in Non-Patent Document 3, an action of each detection result and a group activity are identified. Finally, the activity identification result of each detection result is matched with the track result, and the action of each track result is output.

There are three major problems in the above-described method. The first problem is that the overall architecture is complex and the overall computation cost is high. Noting that the techniques disclosed in Non-Patent Documents 1-3, which are publicly-known techniques for solving respective subtasks listed above, include a common convolutional neural network (CNN) structure, it is also apparent that the overall architecture is excessively redundant.

A second problem is that although the above-described subtasks are related to each other, when activity recognition is performed by simply combining independent methods, interactions between tasks cannot be explicitly considered. For example, for tracking and action recognition, one object (i.e., the track result) is likely to continue the same action over a short time interval, and conversely, the identity of the target object is likely to be useful information for action determination. However, in the method of simply combining independent methods, these interactions cannot be considered, and as a result, the performance of the entire activity recognition cannot be improved.

A third problem is that because subtasks are related to each other, the performance degradation in one subtask strongly affects the performance of the other subtasks. The most prominent example is the effect of the object detection subtask on others. The object detection often fails when the object is occluded in its entirety, i.e. when occlusion occurs. However, in the publicly-known technique of the subtask in which the result of the object detection is input, a model is trained without considering the possibility of such a detection failure. Thus, in a case where an incomplete detection result is input, the model is greatly affected by the input.

In summary, in the method of combining the known techniques as subtasks, because the entire architecture is complicated and redundant, the processing takes time, and the interactions between the subtasks are not considered, there is a problem that the performance of activity recognition is low.

### Outline of an Embodiment

In the following, a technique for solving the above-described problem will be described. First, five features will be described as features of the technique.

<First Feature>

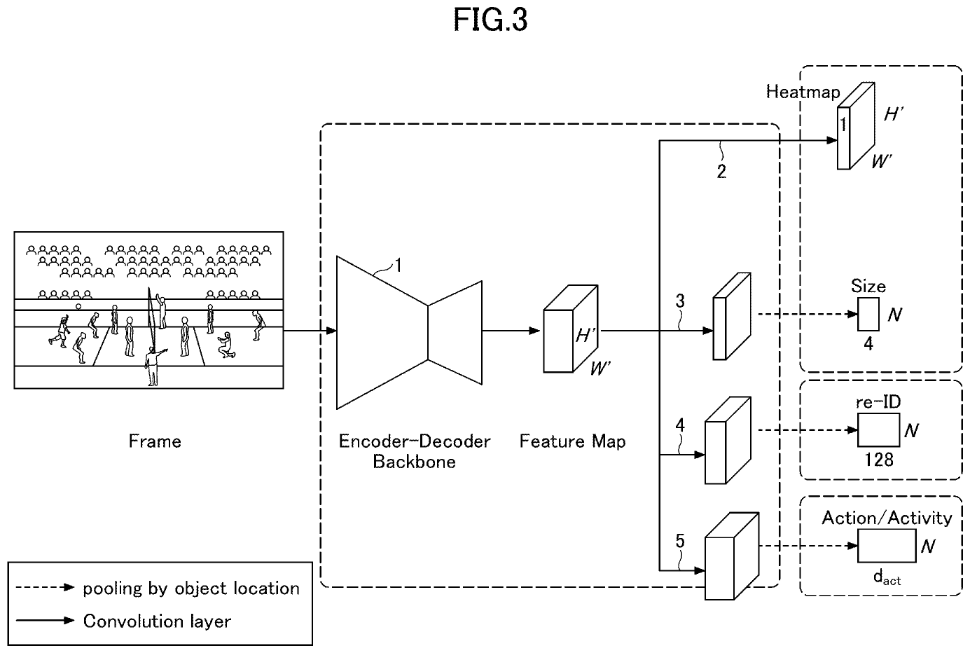

A first feature is to use a convolutional neural network (CNN) configured to output multiple feature representations related to subtasks constituting the activity recognition in one shot based on frames constituting an input video. Specifically, as will be described later with reference to FIG. 3, the CNN includes a backbone 1 configured to extract a feature map from an input frame, a position feature branch 2 configured to output a position feature map indicating a point position of a target object based on the feature map, a size feature branch 3 configured to output a size feature map indicating a size of the target object at each position, a re-identification branch 4 configured to output a re-identification feature map for re-identifying the same object between different frames based on the feature map, and an action feature branch 5 configured to output an action feature map for recognizing individual actions and a group activity.

By sharing a configuration of a feature extractor required for object detection, tracking based on re-identification, and identification of the action/activity, as illustrated on the right side of FIG. 2, the architecture can be simplified and the processing cost can be reduced.

<Second Feature>

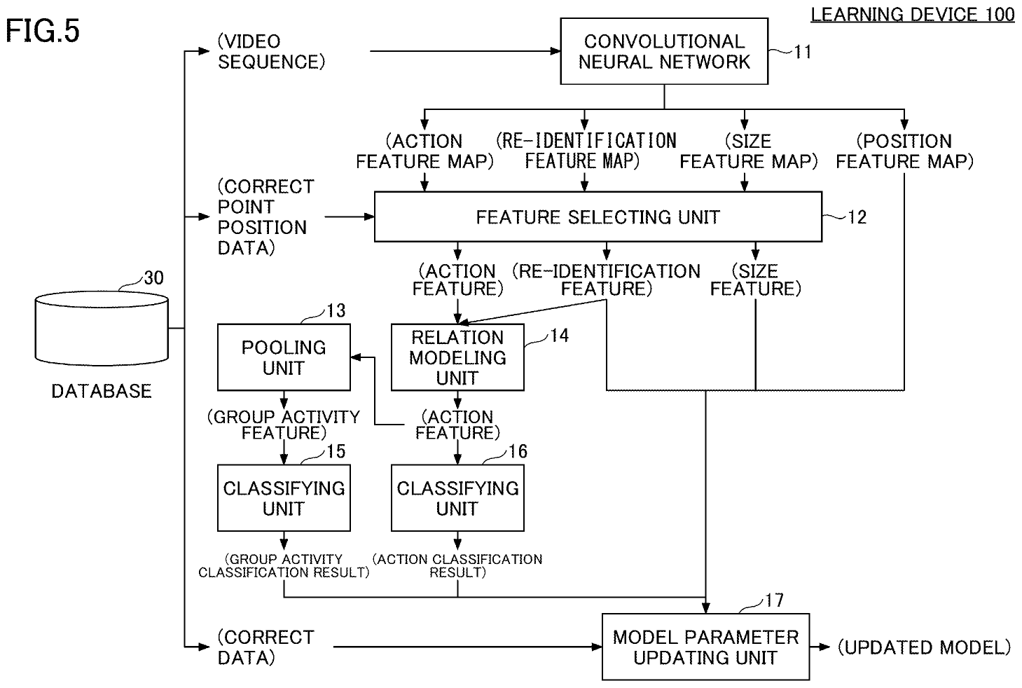

The second feature is a relation modeling unit 14, which will be described later with reference to FIG. 5 and the like. In the processing performed by the relation modeling unit 14, the action feature and the re-identified feature extracted from the input video sequence are input, and the action feature is converted into a feature obtained by considering an interaction between features while the re-identified feature is used as auxiliary information. With this processing, the information on the identity of the target object, which has been described in the second problem, can be considered in determining the action, and as a result, the performance of the action classification and the group activity classification can be improved.

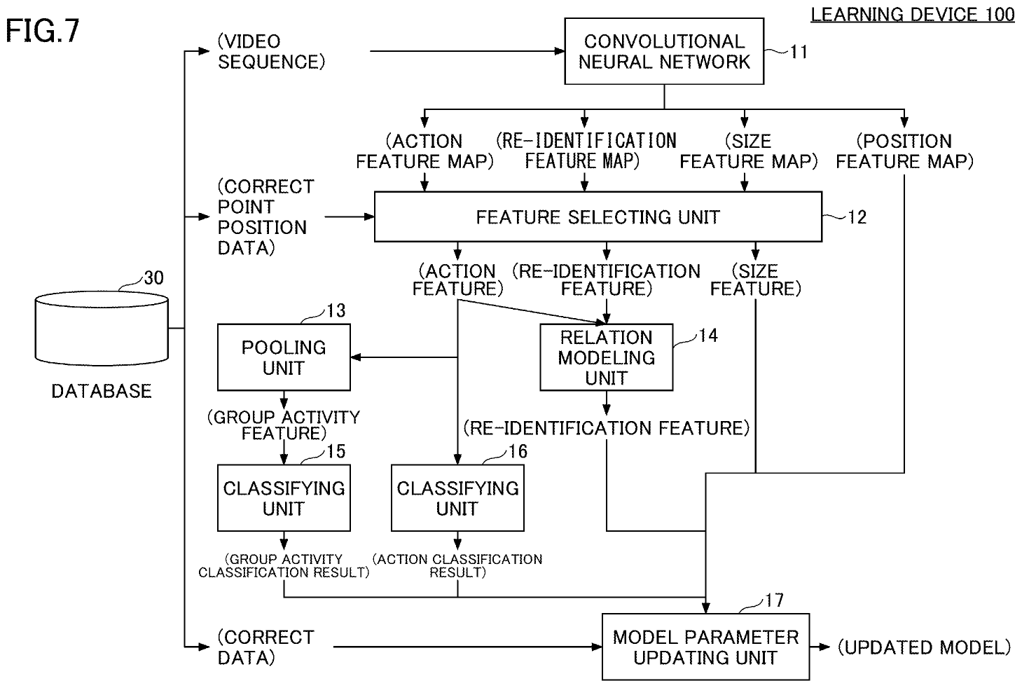

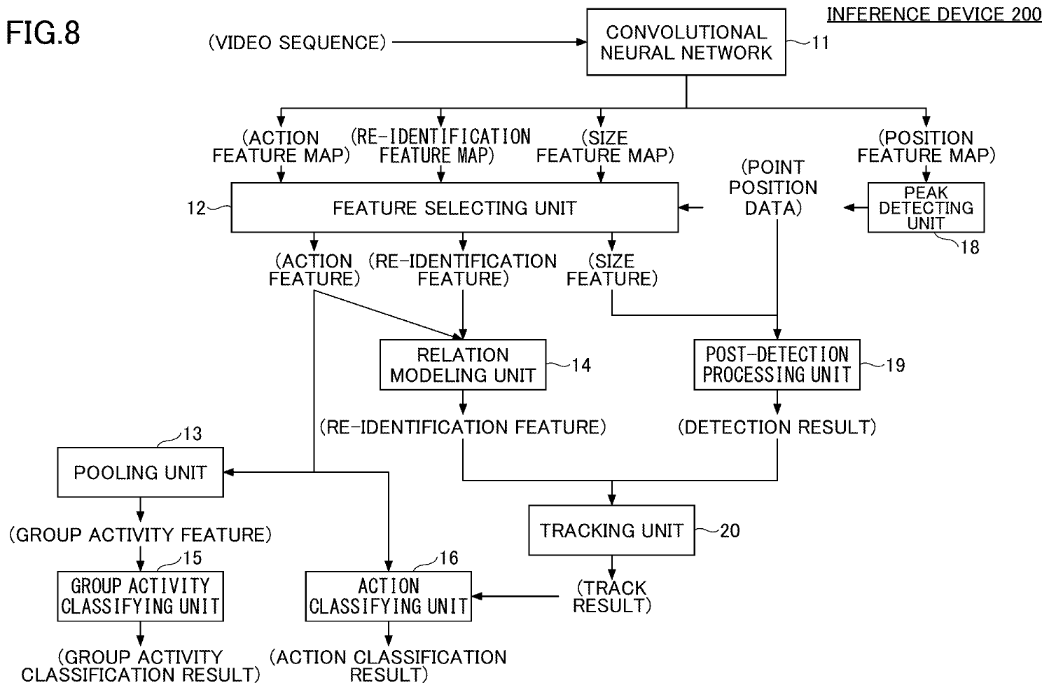

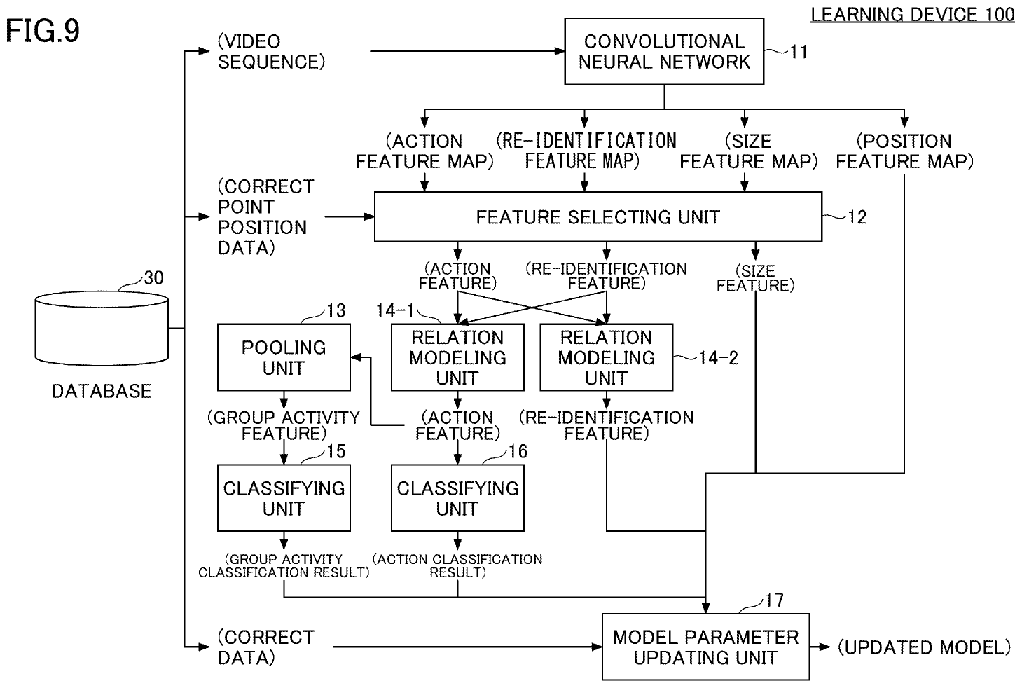

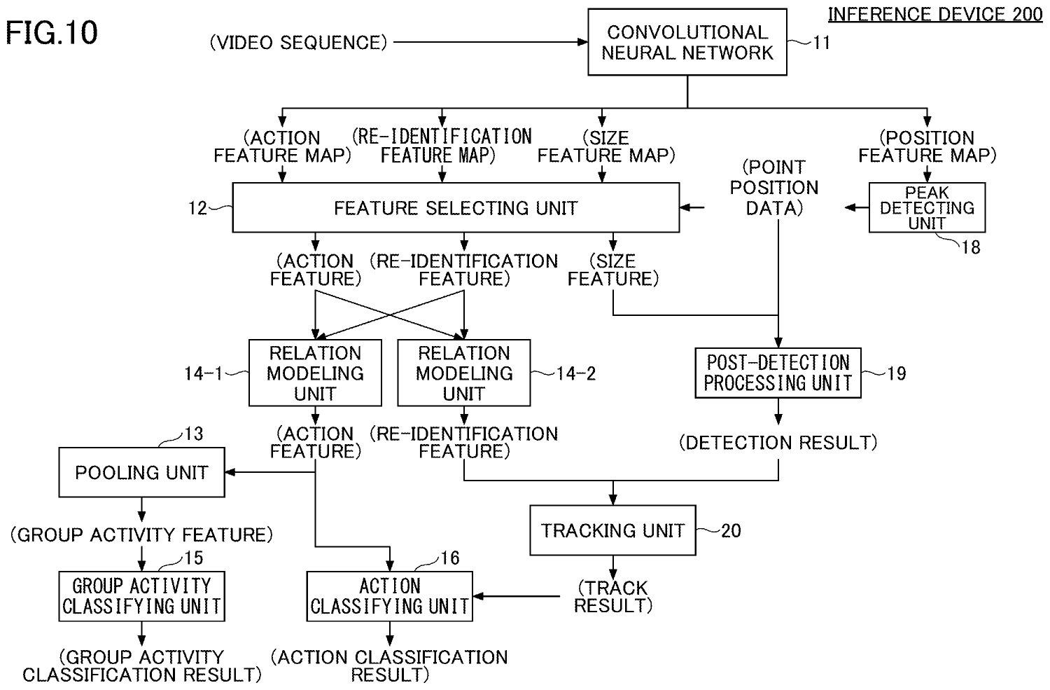

Here, the processing in the relation modeling unit 14 can also convert the re-identification feature using the action feature as auxiliary information (described later with reference to FIG. 7 and FIG. 8). Further, the conversion by the processing of the relation modeling unit 14 can be applied to the action feature and the re-identification feature at the same time (described later with reference to FIGS. 9 and 10).

With this processing, the information on the consistency of the action under the short time interval, which has been described in the second problem, can be used for the conversion of the re-identification feature, and the performance of the tracking and the performance of the entire activity recognition can be improved.

<Third Feature>

The third feature is processing of a feature selecting unit 12, which will be described later with reference to FIG. 5 and the like. The feature selecting unit 12 selects a part of all correct answer target objects based on respective occluding degrees and simulates an incomplete object detection result when learning portions related to tracking based on re-identification, action classification, and group activity classification in the whole model.

By training the model using this method, even if the object detection fails to detect some objects, each action and the group activity can be robustly identified.

<Fourth Feature>

The fourth feature is that in processing of a model parameter updating unit 17, which will be described later with reference to FIG. 5 and the like, all parameters determined by learning among the parameters in the model according to the present embodiment are updated to minimize an error function including an error function related to the position feature map, an error function related to the size feature, an error function related to the re-identification feature, an error function related to the action classification result, and an error function related to the group activity classification result. By using the first, second, and third features together, the model can be trained while considering the relation between the subtasks, and as a result, the performance of the activity recognition can be performed.

<Fifth Feature>

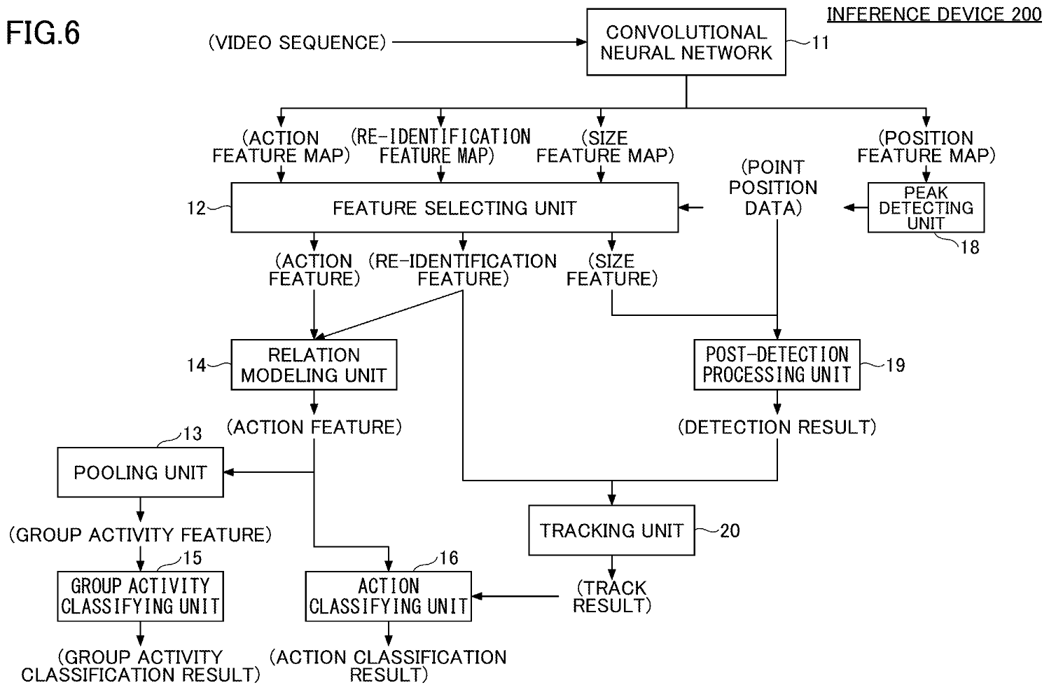

The fifth feature is an action classifying unit 16, which will be described later with reference to FIG. 6 and the like. In processing of the action classifying unit 16, the performance of action classification can be improved by classifying the action of each detection result in consideration of the consistency of the individual from which the detection result is obtained.

<Effects of the Embodiment>

By the technique according to the embodiment having the above five features, activity recognition can be performed with low processing cost and high accuracy. Here, in order to obtain such effects, it is not required to use all of the five features. Such effects can also be obtained by using some of the five features.

In the following, more specific examples of the device configuration and the operation thereof will be described with reference to first to third embodiments. It is assumed that a function in each embodiment described below is implemented by a neural network model. However, the use of the neural network is merely an example, and a machine learning method other than the neural network may be used. Additionally, the neural network and a method other than the neural network may be mixed.

### First Embodiment

First, the first embodiment will be described. FIG. 5 illustrates a configuration of a learning device 100 according to the first embodiment, and FIG. 6 illustrates a configuration of an inference device 200 according to the first embodiment.

The learning device 100 learns a model in response to training data being given. The inference device 200 performs inference on the input video data using the model obtained by the learning device 100, that is, performs detection of a target object appearing in respective frames constituting the video data, tracking of the detected object, identification of an action of each track result, and identification of an activity taken by a group of track results.

Here, the learning device 100 may be used as the inference device 200 by adding a peak detecting unit 18, a post-detection processing unit 19, and a tracking unit 20 to the learning device 100. Additionally, by adding a model parameter updating unit 17 to the inference device 200, learning and inference may be performed only by the inference device 200.

Here, the model is a set of all parameters other than those manually set for performing learning and inference.

<Training Data>

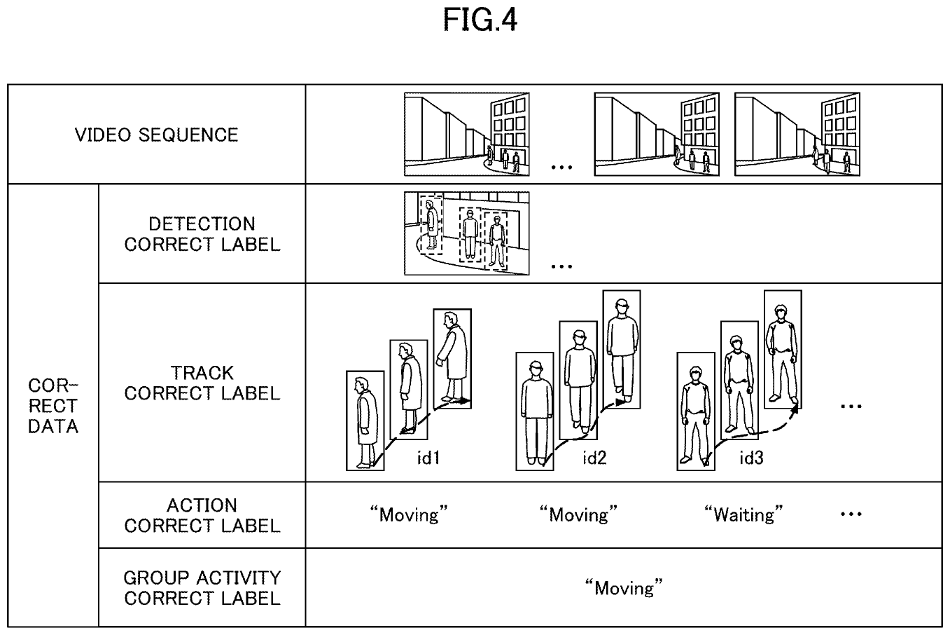

FIG. 4 illustrates an example of the training data used in the learning. FIG. 4 illustrates the training data per one video sequence. As illustrated in FIG. 4, a video sequence and correct data corresponding to the video sequence are used as a unit element. The number of unit elements included in the training data may be any number greater than or equal to one. A video sequence is T image frames arranged in time order. T is suitably selected and may be different for each sequence.

As illustrated in FIG. 4, the correct data corresponding to one sequence includes a detection correct label, a track correct label, an action correct label, and a group activity correct label. The detection correct label is a label related to the position of the target object appearing in each frame of the video sequence, and each can be defined as, for example, a rectangle surrounding the target without excess or deficiency (i.e., a rectangle sufficient enough to surround the target). The track correct label is an id assigned to each detection correct label, and the same and unique id is assigned to a detection correct label targeting the same individual. The action correct label is a label of an action assigned to each tracking id.

In the example of FIG. 4, an action label “Moving” is assigned to id1 and id2, and an operation label “Waiting” is assigned to id3. Here, the action label may be assigned to each detection correct label in addition to being assigned to each tracking target as illustrated in FIG. 4. Finally, the group activity label is assigned per a video sequence, and a label “Moving” is assigned in the example of FIG. 4.

<Configuration of the Learning Device and a Processing Flow>

As illustrated in FIG. 5, the learning device 100 includes a convolutional neural network 11, a feature selecting unit 12, a pooling unit 13, a relation modeling unit 14, a classifying unit 15, a classifying unit 16, and a model parameter updating unit 17. Additionally, there is a database 30 storing the training data. Here, the configuration illustrated in FIG. 5 is merely an example. A certain functional unit may include another functional unit. For example, the classifying unit 15 may include the pooling unit 13. Each unit will be described in detail later. In the following, a processing flow will be described with reference to FIG. 5.

First, respective image frames constituting a video sequence in the training data are input to the convolutional neural network 11, and the neural network 11 outputs a position feature map, a size feature map, a re-identification feature map, and an action feature map.

With respect to the size feature map, the re-identification feature map, and the action feature map corresponding to all the image frames constituting the video sequence, only a feature at a position that is determined to correspond to the correct position data generated from the training data and that is determined not to be affected by the occlusion is selected by the feature selecting unit 12, and the size feature, the re-identification feature, and the action feature are output.

The action feature is input into the relation modeling unit 14, and feature conversion is performed in consideration of the relation and interaction between the objects in the relation modeling unit 14. Here, the re-identification feature is used as auxiliary information for the conversion of the action feature in the relation modeling unit 14. The obtained action feature is input into the pooling unit 13, and the group activity feature is output by performing pooling.

The action feature and the group activity feature are input into the classifying units 16 and 15, and an action classification result and a group activity classification result are output. That is, an action of the target object corresponding to each correct position selected by the feature selecting unit 12 and the group activity corresponding to the video sequence are classified into one of predetermined action categories and one of predetermined group activity categories.

The position feature map, the size feature, the re-identification feature, the action classification result, and the group activity classification result output by the processing up to this point are input into the model parameter updating unit 17 together with the correct data (for example, FIG. 4), and the model parameters are updated so as to minimize the error between the current model output and the correct data.

<Configuration of the Inference Device 200 and a Processing Flow>

FIG. 6 illustrates a configuration of the inference device 200 according to the first embodiment. As illustrated in FIG. 6, the inference device 200 according to the first embodiment includes the convolutional neural network 11, the feature selecting unit 12, the pooling unit 13, the relation modeling unit 14, the group activity classifying unit 15, the action classifying unit 16, the peak detecting unit 18, the post-detection processing unit 19, and the tracking unit 20. Here, the configuration illustrated in FIG. 6 is merely an example. A certain functional unit may include another functional unit. For example, the group activity classifying unit 15 may include the pooling unit 13. Each unit will be described in detail later. In the following, a processing flow will be described with reference to FIG. 6.

Respective image frames constituting an input video sequence, which is an inference object, are input into the convolutional neural network 11, and the position feature map, the size feature map, the re-identification feature map, and the action feature map are output. In the inference processing, unlike the learning processing, the point position of the target object is detected as a peak position of the position feature map in the processing performed by the peak detecting unit 18. The point position, the size feature map, the re-identification feature map, and the action feature map are input into the feature selecting unit 12, and a feature set corresponding to each point position with respect to all image frames is output as the size feature, the re-identification feature, and the action feature.

The point position data and the size feature are output as a detection result through the processing performed by the post-detection processing unit 19. Tracking processing is performed by the tracking unit 20 using the re-identified feature and the detection result as inputs, and the track result is output. As in the learning process, the relation modeling unit 14 converts the action feature, using the re-identification feature as auxiliary information. The action feature output from the relation modeling unit 14 is input into the pooling unit 13, and the group activity feature is output from the pooling unit 13.

The action feature and the track result are input to the action classifying unit 16, and the action label of each track result is output so that the consistency of the action label in each track result is maintained. Additionally, the group activity feature is input to the group activity classifying unit 15, and a group activity classification result is output.

<Detail of Each Unit in the Learning Device 100>

In the following, each unit of the learning device 100 illustrated in FIG. 5 will be described in detail.

<Convolutional Neural Network 11 of the Learning Device 100>

A configuration example of the convolutional neural network (CNN) 11 is as illustrated in FIG. 3. The convolutional neural network is configured to output, in response to the image sequence being input, the position feature map, the size feature map, the re-identification feature map, and the action feature map corresponding to each image frame constituting the image sequence.

The position feature map is a feature map in which a score increases at a position where the target object is present in the input image frame, the size feature map is a feature map that outputs a size of the object captured at each position in the input image frame, the re-identification feature map is a feature map that outputs a feature for associating the object captured at each position in the input image frame with the object in a different frame, and the action feature map is a feature map that outputs a feature for identifying an action of the object captured at each position in the input image frame and a group activity.

Such a CNN can be realized by connecting convolution processing layers in parallel as branches that receive a backbone output of a known encoder-decoder type CNN as an input to output the feature maps described above. For the encoder-decoder type CNN, any technique, for example, the techniques disclosed in Non-Patent Documents 4 and 5 can be used. A method of defining the convolution processing layer is also suitably selected, and by applying a nonlinear processing layer, for example, a rectified linear unit (ReLU) or the like to a subsequent stage of a convolution processing layer having a filter size of 3×3 and subsequently connecting a convolution processing layer having a filter size of 1×1, an output feature map having a desired channel size can be obtained.

In the following example, using an image frame having a size of H×W×3 as an input, a position feature map of H′×W′×1, a size feature map of H′×W′×2, a re-identification feature map of H′×W′×d_{reid}, and an action feature map of H′×W′×d_{act} can be obtained. Here, d_{reid} and d_{act} are arbitrary parameters, and both can be set to, for example, 128.

<Feature Selecting Unit 12 of the Learning Device 100>

The feature selecting unit 12 receives, as input, the size feature map, the re-identification feature map, and the action feature map among the outputs from the convolutional neural network 11, extracts the feature corresponding to the object point position calculated based on the correct data, and outputs the size feature, the re-identification feature, and the action feature.

A method of calculating the object point position based on the correct data is suitably selected. When the object position is defined by a rectangle, the center coordinates thereof may be calculated, and the object point position may be calculated in accordance with the scale ratio between the input image frame size and the output feature map size.

In addition, in the learning process, the feature selecting unit 12 may select only the object point that is not affected by occlusion among the object points calculated based on the correct data. A method of selecting the object point that is not affected by occlusion is suitably selected, and for example, the following method may be used. First, the overlap degree of the correct object position in each image frame is calculated for all objects.

Subsequently, the respective correct objects are arranged in the order from a position closer to the camera. Finally, the object position is determined to be an object position for feature selection in the order from a position closer to the camera, only when the overlap degree with an object positioned closer to the camera is less than or equal to a predetermined threshold.

Here, Intersection-over-Union (IoU) may be used for the calculation of the overlap degree, and the coordinate position on the lower side of the rectangle may be used as a reference for arranging objects in the order from a position closer to the camera. The threshold may be manually determined as a constant in advance, or may be randomly set for each trial.

Here, when the total number of the position data selected from all image frames of the image sequence is N_{seq}, N_{seq}×2 size features are extracted from all the size feature maps, N_{seq}×d_{reid} re-identification features are extracted from all the re-identification feature maps, and N_{seq}×d_{act} action features are extracted from all the action feature maps.

<Relation Modeling Unit 14 of the Learning Device 100>

The relation modeling unit 14 receives, as input, the action feature and the re-identification feature output from the feature selecting unit 12, to output the action feature modified in consideration of the relation between features.

Here, let the number of the total features in the input sequence be N_{seq}. The processing in the relation modeling unit 14 is defined as follows, for example.

When the action feature set is X_{act}∈R^{N_seq×d_act} and the re-identification feature set is X_{reid}∈R^{N_seg×d_reid} the action feature set output by the relation modeling unit 14 is \hat{ }X_{tgt}∈R^{N_seqxd_act}. \hat{ }X_{tgt} is obtained through processing defined by the following equations 1-4.

$$\begin{matrix}[ Equation 1 ] & \\ {h}_{1} = softmax ( \frac{( {X}_{act} {W}_{act}^{Q} ) {( {X}_{act} {W}_{act}^{K} )}^{T}}{\sqrt{{d}_{act} / 2}} ) ( {X}_{act} {W}_{act}^{V} ) & ( 1 )\end{matrix}$$

$$\begin{matrix}[ Equation 2 ] & \\ {h}_{2} = softmax ( \frac{( {X}_{reid} {W}_{reid}^{Q} ) {( {X}_{reid} {W}_{reid}^{K} )}^{T}}{\sqrt{{d}_{reid} / 2}} ) ( {X}_{act} {W}_{reid}^{V} ) & ( 2 )\end{matrix}$$

$$\begin{matrix}[ Equation 3 ] & \\ AGSA ( {X}_{act} , {X}_{reid} ) = concat ( {h}_{1} , {h}_{2} ) {W}^{O} & ( 3 )\end{matrix}$$

$$\begin{matrix}[ Equation 4 ] & \\ {\hat{X}}_{act} = LayerNorm ( {X}_{act} + Dropout ( AGSA ( {X}_{reid} , {X}_{reid} ) ) & ( 4 )\end{matrix}$$

Here, W^{Q}_{act}∈R^{d_act×d_reid/2}, W^{K}_{act}∈R^{d_act×d_act/2}, W^{V}_{act}∈R^{d_act×d_act/2}, W^{Q}_{reid}∈R^{d_reid×d_act/2}, W^{K}_{reid}∈R^{d_reid×d_act/2}, W^{V}_{reid}∈R^{d_reid×d_act/2}, and w^{O}∈R^{d_act×d_act} are parameters, and are optimized in the learning process. Here, the subscript “d_act×d_reid/2” on the upper right side is intended to be “d_{act}×d_{reid}/2” for the convenience of description in the specification text. The same applies to the others. LayerNorm( ) is a normalizing layer disclosed in Non-Patent Document 6, and Dropout( ) is a layer disclosed in Non-Patent Document 7.

<Pooling Unit 13 of the Learning Device 100>

The pooling unit 13 receives, as an input, the action feature output by the relation modeling unit 14 to output a group activity feature for identifying a group activity performed in the sequence. N_{seq}×d_{act} action features are pooled to extract 1×d_{act} group activity features.

Any method can be used for the pooling process, and for example, maximum pooling or average value pooling can be used.

<Classifying Unit 15 and Classifying Unit 16 of the Learning Device 100>

The classifying unit 16 receives, as an input, the action feature output by the relation modeling unit 14 and classifies the target action into one of the predetermined action categories. The classifying unit 15 receives, as an input, the group activity feature output by the pooling unit 13 and classifies the group activity into one of the predetermined group activity categories.

Any method can be used for the classification processing. Here, when the total number of the action categories is Nation, the N_{act}×d_{action} conversion matrix may be applied from the right to the action feature defined by the N_{seq}×d_{act} matrix. It can be interpreted that each element indicates an operation corresponding to an index having a maximum value in a corresponding row of the output matrix.

<Model Parameter Updating Unit 17 of the Learning Device 100>

The model parameter updating unit 17 compares the position feature map output from the convolutional neural network 11, the size feature and the re-identification feature output from the feature selecting unit 12, and the action classification result and the group activity classification result output from the classifying units 16 and 15 with the correct data, respectively, and updates the parameters of an entirety or part of the model so as to minimize the total error. In the following description, an error-function related to the position feature map is Lₕₘ, an error-function related to the size feature is L_{size}, an error-function related to the re-identification feature is L_{reid}, an error-function related to the action classification result is L_{action}, and an error-function related to the group activity classification result is L_{activity}.

A publicly-known method can be used to calculate each of the above-described error functions. For example, Focal loss disclosed in Non-Patent Document 8 may be used as the error-function related to the position feature map Lₕₘ, L1 loss disclosed in Non-Patent Document 8 may be used as the error-function related to the size feature L_{size}, Triplet loss disclosed in Non-Patent Document 9 may be used as the error-function related to the re-identification feature L_{reid}, and cross entropy loss may be used as the error-function related to the action classification result L_{action} and the error-function related to the group activity classification result L_{activity}.

The overall error function can be defined as the weighted sum of Lₕₘ, L_{size}, L_{reid}, L_{action} and L_{activity}. Here, a weight corresponding to each term may be determined manually or may be optimized as a learning parameter in the learning process. When the weight is optimized in the learning process, the objective function is expressed by the following Equation 5. wₕₘ, w_{size}, w_{reid}, w_{action}, and w_{activity} are parameters to be optimized in the learning.

$$\begin{matrix}[ Equation 5 ] & \\ {L}_{total} = {\sum }_{task ∈ \{ hm , size , reid , action , activity \}} [ exp ( - {w}_{task} ) {L}_{task} + {w}_{task} ] & ( 5 )\end{matrix}$$

A publicly-known method can be used to update the parameters of the model based on the above-described error function. For example, the gradient may be calculated by the Adam method disclosed in Non-Patent Document 10, and the parameter of each layer of the model may be updated by the backpropagation method.

<Detail of Each Unit in the Inference Device 200>

In the following, each unit of the inference device 200 illustrated in FIG. 6 will be described in detail.

The convolutional neural network 11, the feature selecting unit 12, the relation modeling unit 14, and the pooling unit 13 are the same in the inference device 200 and the learning device 100. Additionally, the group activity classifying unit 15 of the inference device 200 is the same as the classifying unit 15 of the learning device 100. In the following, a functional unit not included in the learning device 100 and a functional unit different from those included in the learning device 100 will be described.

<Peak Detecting Unit 18 of the Inference Device 200>

The peak detecting unit 18 outputs the point position of the target object based on the position feature map corresponding to each image frame among the outputs of the convolutional neural network 11. The point position can be output as a position where a value greater than or equal to a preset threshold is output in the position feature map. Considering that outputs at positions close to each other in the position feature map are likely to capture the same object, Non-Maximum Suppression (NMS) processing or the like may be performed in advance in order to suppress redundant outputs.

<Post-Detection Processing Unit 19 of the Inference Device 200>

The post-detection processing unit 19 outputs a target object detection result for each image frame based on the point position data output by the peak detecting unit 18 and the size feature output by the feature selecting unit 12. Here, when a certain point position output from the peak detecting unit 18 is (x, y) and a size feature corresponding to the point is (w, h), an object detection result, that is, a rectangle (x₁, y₁, x₂, y₂) is calculated as (x−w/2, y−h/2, x+w/2, y+h/2).

<Tracking Unit 20 of the Inference Device 200>

The tracking unit 20 receives, as an input, the re-identification feature output by the feature selecting unit 12 and the detection result output by the post-detection processing unit 19, associates the detection results capturing the same individual in different image frames, and outputs a result as the track result.

A publicly-known method can be used for the tracking process, and for example, a method disclosed in Non-Patent Document 8 can be used.

<Action Classifying Unit 16 of the Inference Device 200>

The action classifying unit 16 receives, as an input, the action feature output by the relation modeling unit 14 and the track result output by the tracking unit 20, and classifies the target action into one of the predetermined action categories. Any method can be used for the action classification, and, for example, a method substantially the same as the method described in the classifying units 15 and 16 of the learning device 100 can be used.

Alternatively, in a case where it is guaranteed that the same action is performed for each track result, consistency of the action in each track result may be considered. A method of guaranteeing the consistency of the action can be realized by, for example, outputting an action label for each detection result constituting one track result by substantially the same method as the method described in the classifying units 15 and 16 of the learning device 100, determining a majority of action labels in the track result, and replacing the action labels of all detections in the track result with the action label that appears most.

In the following, second and third embodiments will be described, but the second and third embodiments are based on the first embodiment, and portions different from the first embodiment will be mainly described below.

### Second Embodiment

FIG. 7 illustrates a learning device 100 according to the second embodiment, and FIG. 8 illustrates an inference device 200 according to the second embodiment.

In the second embodiment, the re-identification feature output by the feature selecting unit 12 is converted by the relation modeling unit 14 in consideration of the relation between features while using the action feature as auxiliary information. This point is different from the first embodiment. The process performed by the relation modeling unit 14 on the re-identification feature using the action feature as the auxiliary information can be defined as a process in which the roles of the action feature X_{act} and the re-identification feature X_{reid} in the process of the relation modeling unit 14 of the first embodiment are reversed.

### Third Embodiment

FIG. 9 illustrates a learning device 100 according to the third embodiment, and FIG. 10 illustrates an inference device 200 according to the third embodiment.

In the third embodiment, each feature of the action feature and the re-identification feature output by the feature selecting unit 12 is converted by relation modeling units 14-1 and 14-2 in consideration of the relation between features while using the other feature as auxiliary information. This point is different from the first and second embodiments. As a process of each of the relation modeling units 14-1 and 14-2, the same method as the method described in the first and second embodiments can be used.

(Hardware Configuration Example)

Each of the learning device 100 and the inference device 200 (collectively referred to as a device) in the present embodiment can be realized by causing a computer to execute a program, for example. The computer may be a physical computer or may be a virtual machine on a cloud.

That is, the device can be realized by executing a program corresponding to the processing performed by the device, using hardware resources such as a central processing unit (CPU) and a memory built in the computer. The above-described program may be recorded in a computer-readable recording medium (such as a portable memory), so that the recording medium can be stored and distributed. Additionally, the above-described program can be provided through a network such as the Internet or an electronic mail.

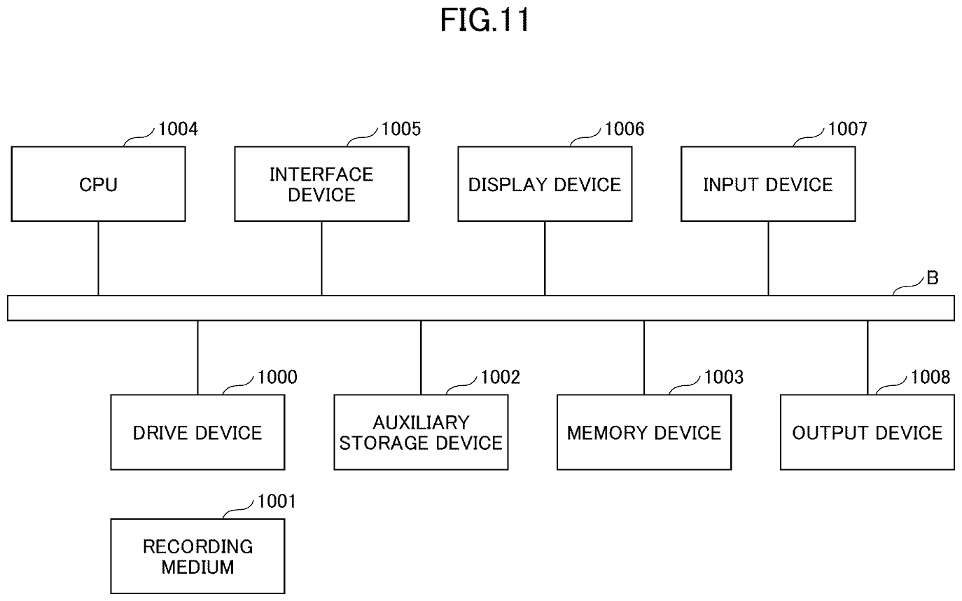

FIG. 11 is a diagram illustrating a hardware configuration example of the computer. The computer illustrated in FIG. 11 includes a drive device 1000, an auxiliary storage device 1002, a memory device 1003, a CPU 1004, an interface device 1005, a display device 1006, an input device 1007, an output device 1008, and the like, which are connected to each other via a bus B.

A program for implementing the processing in the computer is provided by the recording medium 1001 such as a compact disk read only memory (CD-ROM) or a memory card, for example. When the recording medium 1001 storing the program is set in the drive device 1000, the program is installed from the recording medium 1001 to the auxiliary storage device 1002 via the drive device 1000. However, it is not necessarily required to install the program by the recording medium 1001, and the program may be downloaded from another computer via a network. The auxiliary storage device 1002 stores the installed program and also stores necessary files, data, and the like.

The memory device 1003 reads out the program from the auxiliary storage device 1002 and stores the program in response to an instruction to start the program. The CPU 1004 realizes a function related to the device according to the program stored in the memory device 1003. The interface device 1005 is used as an interface for connecting to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result.

### Summary of the Embodiments

The present specification discloses at least the following items of a learning device, an inference device, a learning method, an inference method, and a program.

### (Item 1)

A learning device that performs learning for activity recognition including:
a convolutional neural network configured to output an action feature map, a re-identification feature map, a size feature map, and a position feature map, in response to respective image frames constituting an image sequence being input;
a feature selecting unit configured to receive the action feature map, the re-identification feature map, and the size feature map to output an action feature, a re-identification feature, and a size feature;
a relation modeling unit configured to receive the action feature and the re-identification feature to output a feature obtained by considering an interaction between features;
a first classifying unit configured to output a group activity classification result based on the feature output by the relation modeling unit;
a second classifying unit configured to output an action classification result based on the feature output by the relation modeling unit; and
a model parameter updating unit configured to update model parameters of the convolutional neural network, the feature selecting unit, the relation modeling unit, the first classifying unit, and the second classifying unit so as to minimize an error between the position feature map, the size feature, the re-identification feature, the group activity classification result, and the action classification result; and correct data.

### (Item 2)

The learning device as described in item 1, wherein the relation modeling unit converts the action feature by using the re-identification feature as auxiliary information, or converts the re-identification feature by using the action feature as the auxiliary information.

### (Item 3)

The learning device as described in item 1, wherein the relation modeling unit includes a first relation modeling unit and a second relation modeling unit, the first relation modeling unit converts the action feature by using the re-identification feature as auxiliary information, and the second relation modeling unit converts the re-identification feature by using the action feature as the auxiliary information.

### (Item 4)

An inference device that performs inference for activity recognition, including:
a convolutional neural network configured to output an action feature map, a re-identification feature map, a size feature map, and a position feature map, in response to respective image frames constituting an image sequence being input;
a feature selecting unit configured to receive point position data obtained based on the position feature map, the action feature map, the re-identification feature map, and the size feature map to output an action feature, a re-identification feature, and a size feature;
a tracking unit configured to receive a detection result and the re-identification feature to output a track result, the detection result being obtained based on the point position data and the size feature;
a relation modeling unit configured to receive the action feature and the re-identification feature to output a feature obtained by considering an interaction between features;
a group activity classifying unit configured to output a group activity classification result based on the feature output by the relation modeling unit; and
an action classifying unit configured to output an action classification result based on the feature output by the relation modeling unit and the track result.

### (Item 5)

The inference device as described in item 4, wherein the relation modeling unit converts the action feature by using the re-identification feature as auxiliary information, or converts the re-identification feature by using the action feature as the auxiliary information.

### (Item 6)

The inference device as described in item 4, wherein the relation modeling unit includes a first relation modeling unit and a second relation modeling unit, the first relation modeling unit converts the action feature by using the re-identification feature as auxiliary information, and the second relation modeling unit converts the re-identification feature by using the action feature as the auxiliary information.

### (Item 7)

A learning method performed by a learning device that performs learning for activity recognition, the learning method including:
a step of inputting respective image frames constituting a video sequence into a convolutional neural network to output an action feature map, a re-identification feature map, a size feature map, and a position feature map;
a step of receiving, by a feature selecting unit, the action feature map, the re-identification feature map, and the size feature map to output an action feature, a re-identification feature, and a size feature;
a step of receiving, by a relation modeling unit, the action feature and the re-identification feature to output a feature obtained by considering an interaction between features;
a step of outputting, by a first classifying unit, a group activity classification result based on the feature output by the relation modeling unit;
a step of outputting, by a second classifying unit, an action classification result based on the feature output by the relation modeling unit; and
a step of updating model parameters of the convolutional neural network, the feature selecting unit, the relation modeling unit, the first classifying unit, and the second classifying unit so as to minimize an error between the position feature map, the size feature, the re-identification feature, the group activity classification result, and the action classification result; and correct data.

### (Item 8)

An inference method performed by an inference device that performs inference for activity recognition, the inference method including:
a step of inputting respective image frames constituting a video sequence into a convolutional neural network to output an action feature map, a re-identification feature map, a size feature map, and a position feature map;
a step of receiving, by a feature selecting unit, point position data obtained based on the position feature map, the action feature map, the re-identification feature map, and the size feature map to output an action feature, a re-identification feature, and a size feature;
a step of receiving, by a tracking unit, a detection result and the re-identification feature to output a track result, the detection result being obtained based on the point position data and the size feature;
a step of receiving, by a relation modeling unit, the action feature and the re-identification feature to output a feature obtained by considering an interaction between features;
a step of outputting, by a group activity classifying unit, a group activity classification result based on the feature output from the relation modeling unit; and
a step of outputting, by an action classifying unit, an action classification result based on the feature output by the relation modeling unit and the track result.

### (Item 9)

A program for causing a computer to function as the learning device as described in any one of items 1 to 3.

### (Item 10)

A program for causing a computer to function as the inference device as described in any one of items 4 to 6.

Although the embodiments have been described above, the present invention is not limited to the specific embodiments, and various modifications and changes can be made within the scope of the gist of the present invention described in the claims.

What is claimed is:

1. A learning device that performs learning for activity recognition, comprising:
a convolutional neural network configured to output an action feature map, a re-identification feature map, a size feature map, and a position feature map in response to respective image frames constituting a video sequence being input;
a processor; and
a memory storing program instructions that cause the processor to:
receive the action feature map, the re-identification feature map, and the size feature map to output an action feature, a re-identification feature, and a size feature;
receive the action feature and the re-identification feature to output a feature obtained by considering an interaction between features;
output a group activity classification result based on the output feature;
output an action classification result based on the output feature; and
update model parameters of the convolutional neural network so as to minimize an error between the position feature map, the size feature, the re-identification feature, the group activity classification result, and the action classification result; and correct data.

2. The learning device as claimed in claim 1, wherein the processor converts the action feature by using the re-identification feature as auxiliary information or converts the re-identification feature by using the action feature as the auxiliary information.

3. The learning device as claimed in claim 1, wherein the processor converts the action feature by using the re-identification feature as auxiliary information, and converts the re-identification feature by using the action feature as the auxiliary information.

4. An inference device that performs inference for activity recognition, comprising:
a convolutional neural network configured to output an action feature map, a re-identification feature map, a size feature map, and a position feature map in response to respective image frames constituting an image sequence being input;
a processor; and
a memory storing program instructions that cause the processor to:
receive point position data obtained based on the position feature map, the action feature map, the re-identification feature map, and the size feature map to output an action feature, a re-identification feature, and a size feature;
receive a detection result and the re-identification feature to output a track result, the detection result being obtained based on the point position data and the size feature;
receive the action feature and the re-identification feature to output a feature obtained by considering an interaction between features;
output a group activity classification result based on the output feature; and
output an action classification result based on the output feature and the track result.

5. The inference device as claimed in claim 4, wherein the processor converts the action feature by using the re-identification feature as auxiliary information, or converts the re-identification feature by using the action feature as the auxiliary information.

6. The inference device as claimed in claim 4, wherein the processor converts the action feature by using the re-identification feature as auxiliary information, and converts the re-identification feature by using the action feature as the auxiliary information.

7. A learning method executed by a learning device that performs learning for activity recognition, the learning method comprising:
inputting respective image frames constituting a video sequence into a convolutional neural network to output an action feature map, a re-identification feature map, a size feature map, and a position feature map;
receiving the action feature map, the re-identification feature map, and the size feature map to output an action feature, a re-identification feature, and a size feature;
receiving the action feature and the re-identification feature to output a feature obtained by considering an interaction between features;
outputting a group activity classification result based on the output feature;
outputting an action classification result based on the output feature; and
updating model parameters of the convolutional neural network so as to minimize an error between the position feature map, the size feature, the re-identification feature, the group activity classification result, and the action classification result; and correct data.

8. An inference method executed by an inference device that performs inference for activity recognition, the inference method comprising:
inputting respective image frames constituting a video sequence into a convolutional neural network to output an action feature map, a re-identification feature map, a size feature map, and a position feature map;
receiving point position data obtained based on the position feature map, the action feature map, the re-identification feature map, and the size feature map to output an action feature, a re-identification feature, and a size feature;
receiving a detection result and the re-identification feature to output a track result, the detection result being obtained based on the point position data and the size feature;
receiving the action feature and the re-identification feature to output a feature obtained by considering an interaction between features;
outputting a group activity classification result based on the output feature; and
outputting an action classification result based on the output feature and the track result.

9. A non-transitory computer-readable recording medium storing a program for causing a computer to perform the learning method as claimed in claim 7.

10. A non-transitory computer-readable recording medium storing a program for causing a computer to function as the inference method as claimed in claim 8.
